(19) United States
(12) Patent Application Publication
(10) Pub. No.: US 2019/0158592 A1
(43) Pub. Date: May 23, 2019

(54) CLOUD COMMUNICATION NETWORK SYSTEM, DEVICE, METHOD, AND COMPUTER-READABLE MEDIUM

(71) Applicant: FIO CORPORATION, Toronto (CA)

(72) Inventors: Bayan Qandil, Toronto (CA); Ian Fine, Toronto (CA)

(21) Appl. No.: 16/314,379

(22) PCT Filed: Jun. 30, 2017
(86) PCT No.: PCT/CA2017/000165

§ 371 Date: Dec. 28, 2018

Related U.S. Application Data
(60) Provisional application No. 62/356,979, filed on Jun. 30, 2016.

(51) Int. Cl. H04L 29/08; G06Q 10/10

(52) U.S. Cl. CPC H04L 67/1095; H04L 67/32; H04L 67/1097; G06Q 10/10

(57) ABSTRACT

The present invention is directed to a system for facilitating the communication of data in a cloud communication network in an unstable connectivity setting. A data transport device is used to automatically synchronize data with a source cloud and subsequently upload the source cloud data to a target cloud.

### RELATED APPLICATIONS

The present application claims the benefit of the earlier filed U.S. Patent Provisional Application No. 62/356,979 filed on Jun. 30, 2016.

### FIELD OF THE INVENTION

The present invention relates generally to a cloud communication network system, device, method, computer-readable medium, and/or cooperating environment.

### BACKGROUND OF THE INVENTION

In some instances a user can have access to multiple clouds or virtual storage resources. In these instances, a user can use the clouds to store information and to access resources available to the user in the cloud. Clouds can be provided by one or more types of services and can be dedicated to specific functions. For example, a user can have one cloud dedicated to clinical information and applications, and another cloud dedicated to operational applications and information uploaded by a user. There may be points in time when it is desirable to be able to access information and resources available in one cloud from within another cloud.

Communication between clouds can be difficult in situations where the data connectivity between clouds is inconsistent, weak or intermittent. This may result in incomplete, or a failure, to transfer data between clouds. Thus, systems and methods are required to address the difficulties that arise from trying to establish a communication bridge between two different clouds.

As a result, there may be a need for, or it may be desirable to provide, one or more cloud communication network systems, platforms, devices, methods, computer-readable media, and/or cooperating environments.

It may be an object of the present invention to obviate or mitigate one or more disadvantages and/or shortcomings associated with the prior art, to meet or provide for one or more needs and/or advantages, and/or to achieve one or more objects of the invention—one or more of which may preferably be readily appreciable by and/or suggested to those skilled in the art in view of the teachings and/or disclosures hereof

### SUMMARY OF THE INVENTION

The present disclosure provides a device, method, computer-readable medium and system for data transfer. More specifically, embodiments of the present invention are directed to a device, method, computer-readable medium and system for transferring data in a cloud communication network system comprising: (a) a source cloud in communication with a network comprising: (i) a first cloud database configured to store source data; (ii) a first business specific web services engine; (iii) a first data routing engine; (iv) a first application programming interface engine; (v) a first data normalization component; and (vi) a first data transmission configuration engine to generate configured source data; (b) a target cloud in communication with the network comprising: (i) a second cloud database configured to store target data and/or synchronized data; (ii) a second business specific web services engine; (iii) a second data routing engine; (iv) a first application programming interface engine; (v) a second data transmission configuration engine; and (vi) a second data normalization engine to analyze and categorize the configured source data; and (c) a data transport device adapted to automatically receive the configured source data from the first data transmission configuration engine and transmit the configured source data to the second data normalization engine to generate the synchronized data; whereby the configured source data can be transmitted from the source cloud to the target cloud in unstable connectivity settings.

In another embodiment of the present invention, there is provided a method for transferring data in a cloud communication network system with unstable connectivity settings, comprising: (a) providing a source cloud in communication with a with a network comprising: (i) a first cloud database configured to store source data; (ii) a first business specific web services engine; (iii) a first data routing engine; (iv) a first application programming interface engine; (v) a first data normalization component; and (vi) a first data transmission configuration engine to generate configured source data; (b) providing a target cloud in communication with the network comprising: (i) a second cloud database configured to store target data and/or synchronized data; (ii) a second business specific web services engine; (iii) a second data routing engine; (iv) a first application programming interface engine; (v) a second data transmission configuration engine; and (vi) a second data normalization engine to analyze and categorize the configured source data; (c) automatically transmitting the configured source data from the first data transmission configuration engine to a data transport device; and (d) automatically transmitting the configured source data from the data transport device to the second data normalization engine to generate the synchronized data.

In yet another embodiment of the present invention, there is provided a non-transitory computer readable medium encoded with executable instructions for transferring data in a cloud communication network system with unstable connectivity settings, comprising: (a) providing a source cloud in communication with a with a network comprising: (i) a first cloud database configured to store source data; (ii) a first business specific web services engine; (iii) a first data routing engine; (iv) a first application programming interface engine; (v) a first data normalization component; and (vi) a first data transmission configuration engine to generate configured source data; (b) providing a target cloud in communication with the network comprising: (i) a second cloud database configured to store target data and/or synchronized data; (ii) a second business specific web services engine; (iii) a second data routing engine; (iv) a first application programming interface engine; (v) a second data transmission configuration engine; and (vi) a second data normalization engine to analyze and categorize the configured source data; (c) automatically transmitting the configured source data from the first data transmission configuration engine to a data transport device; and (d) automatically transmitting the configured source data from the data transport device to the second data normalization engine to generate the synchronized data.

In a preferred embodiment of the present invention, the above noted system, method and/or computer readable medium further provides that the first and/or second business specific web services engine generates specific business functions selected from the group consisting of inventory tracking, medical protocols and reports.

In yet a further preferred embodiment of the present invention, the above noted system, method and/or computer readable medium further provides that the first and/or second application programming interface engine sends and receives different types of data items.

In yet a further preferred embodiment of the present invention, the above noted system, method and/or computer readable medium further provides that the first and/or second data routing engine automatically determine if new or existing data items should be sent to another related cloud system.

In yet a further preferred embodiment of the present invention, the above noted system, method and/or computer readable medium further provides that the first and/or second data transmission configuration engines configure data using data category, data item and/or data item attribute.

In yet a further preferred embodiment of the present invention, the above noted system, method and/or computer readable medium further provides that the first and/or second database comprises data elements selected from the group consisting of: data elements for cloud operation; data elements for storage, configuration parameters for data routing engine, configuration parameters for data transmission engine, and configuration parameters for data normalization engine.

In yet a further preferred embodiment of the present invention, the above noted system, method and/or computer readable medium further provides that the system comprises shared hardware, a virtual machine, a shared virtual machine and/or a dedicated hardware configuration.

In yet a further preferred embodiment of the present invention, the above noted system, method and/or computer readable medium further adapted to connect to multiple users and/or client devices. the source clouds.

In yet a further preferred embodiment of the present invention, the above noted system, method and/or computer readable medium further provides that the source data, the target data and/or the synchronized data is selected from the group consisting of clinical data, operational data, device content data, configuration data, temporary and permanent data.

In yet a further preferred embodiment of the present invention, the above noted system, method and/or computer readable medium further provides that the cloud systems can be local or remote.

In yet a further preferred embodiment of the present invention, the above noted system, method and/or computer readable medium further comprises a plurality of clouds having a hierarchy configuration, a mesh configuration, or a hybrid configuration.

### BRIEF DESCRIPTION OF THE DRAWINGS

The novel features which are believed to be characteristic of the system, device and methods according to the present invention, as to their structure, organization, use, and method of operation, together with further objectives and advantages thereof, may be better understood from the following drawings in which presently preferred embodiments of the invention may now be illustrated by way of example. It is expressly understood, however, that the drawings are for the purpose of illustration and description only, and are not intended as a definition of the limits of the invention. In the accompanying drawings:

FIG. 1 is a pictorial representation of an example distributed data processing system in which aspects of the embodiments of the present invention may be implemented;

FIG. 2 is a schematic diagram of an embodiment of the present invention;

FIG. 3 is a schematic diagram of a further embodiment of the present invention;

FIGS. 4A-C are schematic diagrams of various embodiments of the present invention;

FIG. 5 is a schematic diagram of yet another embodiment of the present invention;

FIG. 6 is a flowchart of yet another embodiment of the present invention;

FIG. 7 is a schematic diagram of a further embodiment of the present invention; and

FIG. 8 is a schematic diagram of yet another embodiment of the present invention.

### DETAILED DESCRIPTION OF THE PREFERRED EMBODIMENTS

The description that follows, and the embodiments described therein, may be provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly depict certain embodiments and features of the invention.

The present disclosure may be described herein with reference to system architecture, block diagrams and flowchart illustrations of methods, and computer program products according to various aspects of the present disclosure. It may be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It may also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The present disclosure may be now described in terms of an exemplary system in which the present disclosure, in various embodiments, would be implemented. This may be for convenience only and may be not intended to limit the application of the present disclosure. It may be apparent to one skilled in the relevant art(s) how to implement the present disclosure in alternative embodiments.

In this disclosure, a number of terms and abbreviations may be used. The following definitions and descriptions of such terms and abbreviations are provided in greater detail.

As used herein, a person skilled in the relevant art may generally understand the term “comprising” to generally mean the presence of the stated features, integers, steps, or components as referred to in the claims, but that it does not preclude the presence or addition of one or more other features, integers, steps, components or groups thereof.

As used herein, a person skilled in the relevant art may generally understand the term “cloud” to refer to a set of software services, a database, hardware to host the database and services.

As used herein, a person skilled in the relevant art may generally understand the term “portal” to refer to one or more web pages that allow, manipulation of cloud settings, viewing of data in the cloud database and/or transfer of data between cloud databases.

It should also be appreciated that the present invention can be implemented in numerous ways, including as a process, method, an apparatus, a system, a device, a method, or a computer readable medium such as a computer readable storage medium or a computer network wherein program instructions are sent over a network (e.g. optical or electronic communication links). In this specification, these implementations, or any other form that the invention may take, may be referred to as processes. In general, the order of the steps of the disclosed processes may be altered within the scope of the invention.

Preferred embodiments of the present invention can be implemented in numerous configurations depending on implementation choices based upon the principles described herein. Various specific aspects are disclosed, which are illustrative embodiments not to be construed as limiting the scope of the disclosure. One aspect of the disclosure is a method, computer program product, apparatus, and system for the exchange of data between two or more cloud systems. Although the present specification describes components and functions implemented in the embodiments with reference to standards and protocols known to a person skilled in the art, the present disclosures as well as the embodiments of the present invention are not limited to any specific standard or protocol. Each of the standards for non-mobile and mobile computing, including the Internet and other forms of computer network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

As those of ordinary skill in the art would generally understand, the Internet is a global computer network which comprises a vast number of computers and computer networks which are interconnected through communication links. A person skilled in the relevant art may understand that an electronic communications network of the present invention, may include, but is not limited to, one or more of the following: a local area network, a wide area network, peer to peer communication, an intranet, or the Internet. The interconnected computers exchange information using various services, including, but not limited to, electronic mail, Gopher, web-services, application programming interface (API), File Transfer Protocol (FTP). This network allows a server computer system (a Web server) to send graphical Web pages of information to a remote client computer system. The remote client computer system can then display the Web pages via its web browser. Each Web page (or link) of the “world wide web” (“WWW”) is uniquely identifiable by a Uniform Resource Locator (URL). To view a specific Web page, a client computer system specifies the URL for that Web page in a request (e.g., a HyperText Transfer Protocol (“HTTP”) request). The request is forwarded to the Web server that supports the Web page. When the Web server receives the request, it sends the Web page to the client computer system. When the client computer system receives the Web page, it typically displays the Web page using a browser. A web browser or a browser is a special-purpose application program that effects the requesting of web pages and the displaying of web pages and the use of web-based applications. Commercially available browsers include Microsoft Internet Explorer and Firefox, Google Chrome among others. It may be understood that with embodiments of the present invention, any browser would be suitable.

A person skilled in the relevant art would generally understand that a reference to “Internet of Things (IoT)” or “IoT device” refers to networked or interconnected objects, typically, but not limited to, everyday objects, more technically purposed objects (i.e., medical devices) and devices. It is described as a self-configuring wireless network of sensors whose purpose would be to interconnect all such connected devices. The concept may be attributed to the former Auto-ID Center, founded in 1999, based at the time at the Massachusetts Institute of Technology (MIT).

Web pages are typically defined using HTML. HTML provides a standard set of tags that define how a Web page is to be displayed. When a provider indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

A person skilled in the relevant art may generally understand a web-based application refers to any program that is accessed over a network connection using HTTP, rather than existing within a device's memory. Web-based applications often run inside a web browser or web portal. Web-based applications also may be client-based, where a small part of the program is downloaded to a user's desktop, but processing is done over the Internet on an external server. Web-based applications may also be dedicated programs installed on an internet-ready device, such as a smart phone or tablet. A person skilled in the relevant art may understand that a web site may also act as a web portal. A web portal may be a web site that provides a variety of services to users via a collection of web sites or web based applications. A portal is most often one specially designed site or application that brings information together from diverse sources in a uniform way. Usually, each information source gets its dedicated area on the page for displaying information (a portlet); often, the user can configure which ones to display. Portals typically provide an opportunity for users to input information into a system. Variants of portals include “dashboards”. The extent to which content is displayed in a “uniform way” may depend on the intended user and the intended purpose, as well as the diversity of the content. Very often design emphasis is on a certain “metaphor” for configuring and customizing the presentation of the content and the chosen implementation framework and/or code libraries. In addition, the role of the user in an organization may determine which content can be added to the portal or deleted from the portal configuration.

It may be generally understood by a person skilled in the relevant art that the term “mobile device” or “portable device” refers to any portable electronic device that can be used to access a computer network such as, for example, the internet. Typically a portable electronic device comprises a display screen, at least one input/output device, a processor, memory, a power module and a tactile man-machine interface as well as other components that are common to portable electronic devices individuals or members carry with them on a daily basis. Examples of portable devices suitable for use with the present invention include, but are not limited to, smart phones, cell phones, wireless data/email devices, tablets, PDAs and MP3 players, test devices, etc.

It may be generally understood by a person skilled in the relevant art that the term “network ready device” or “internet ready device” refers to devices that are capable of connecting to and accessing a computer network, such as, for example, the Internet, including but not limited to an IoT device. A network ready device may assess the computer network through well-known methods, including, for example, a web-browser. Examples of internet-ready devices include, but are not limited to, mobile devices (including smart-phones, tablets, PDAs, etc.), gaming consoles, and smart-TVs. It may be understood by a person skilled in the relevant art that embodiment of the present invention may be expanded to include applications for use on a network ready device (e.g. cellphone). In a preferred embodiment, the network ready device version of the applicable software may have a similar look and feel as a browser version but that may be optimized to the device. It may be understood that other “smart” devices (devices that are capable of connecting to and accessing a computer network, such as, for example, the internet) such as medical or test devices, including but not limited to smart blood pressure monitors, smart glucometers, IoT devices, etc.

It may be further generally understood by a person skilled in the relevant art that the term “downloading” refers to receiving datum or data to a local system (e.g. mobile device) from a remote system (e.g. a client) or to initiate such a datum or data transfer. Examples of a remote systems or clients from which a download might be performed include, but are not limited to, web servers, FTP servers, email servers, or other similar systems. A download can mean either any file that may be offered for downloading or that has been downloaded, or the process of receiving such a file. A person skilled in the relevant art may understand the inverse operation, namely sending of data from a local system (e.g. mobile device) to a remote system (e.g. a database) may be referred to as “uploading”. The data and/or information used according to the present invention may be updated constantly, hourly, daily, weekly, monthly, yearly, etc. depending on the type of data and/or the level of importance inherent in, and/or assigned to, each type of data. Some of the data may preferably be downloaded from the Internet, by satellite networks or other wired or wireless networks.

Elements of the present invention may be implemented with computer systems which are well known in the art. Generally speaking, computers include a central processor, system memory, and a system bus that couples various system components including the system memory to the central processor. A system bus may be any of several types of bus structures including a memory bus or memory controller, a peripheral bus, and a local bus using any of a variety of bus architectures. The structure of a system memory may be well known to those skilled in the art and may include a basic input/output system (“BIOS”) stored in a read only memory (“ROM”) and one or more program modules such as operating systems, application programs and program data stored in random access memory (“RAM”). Computers may also include a variety of interface units and drives for reading and writing data. A user of the system can interact with the computer using a variety of input devices, all of which are known to a person skilled in the relevant art.

One skilled in the relevant art would appreciate that the device connections mentioned herein are for illustration purposes only and that any number of possible configurations and selection of peripheral devices could be coupled to the computer system.

Computers can operate in a networked environment using logical connections to one or more remote computers or other devices, such as a server, a router, a network personal computer, a peer device or other common network node, a wireless telephone or wireless personal digital assistant. The computer of the present invention may include a network interface that couples the system bus to a local area network (“LAN”). Networking environments are commonplace in offices, enterprise-wide computer networks and home computer systems. A wide area network (“WAN”), such as the Internet, can also be accessed by the computer or mobile device.

It may be appreciated that the type of connections contemplated herein are exemplary and other ways of establishing a communications link between computers may be used in accordance with the present invention, including, for example, mobile devices and networks. The existence of any of various well-known protocols, such as TCP/IP, Frame Relay, Ethernet, FTP, HTTP and the like, may be presumed, and computer can be operated in a client-server configuration to permit a user to retrieve and send data to and from a web-based server. Furthermore, any of various conventional web browsers can be used to display and manipulate data in association with a web based application.

The operation of the network ready device (i.e., a mobile device) may be controlled by a variety of different program modules, engines, etc. Examples of program modules are routines, algorithms, programs, objects, components, data structures, etc. that perform particular tasks or implement particular abstract data types. It may be understood that the present invention may also be practiced with other computer system configurations, including multiprocessor systems, microprocessor-based or programmable consumer electronics, network PCS, personal computers, minicomputers, mainframe computers, and the like. Furthermore, the invention may also be practiced in distributed computing environments where tasks are performed by remote processing devices that are linked through a communications network. In a distributed computing environment, program modules may be located in both local and remote memory storage devices.

Embodiments of the present invention can be implemented by a software program for processing data through a computer system. It may be understood by a person skilled in the relevant art that the computer system can be a personal computer, mobile device, notebook computer, server computer, mainframe, networked computer (e.g., router), workstation, and the like. In one embodiment, the computer system includes a processor coupled to a bus and memory storage coupled to the bus. The memory storage can be volatile or non-volatile (i.e. transitory or non-transitory) and can include removable storage media. The computer can also include a display, provision for data input and output, etc. as may be understood by a person skilled in the relevant art.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It may be generally understood that in establishing a user interface, a task bar may be preferably positioned at the top of a screen to provide a user interface. Preferably, a textual representation of a task's name is presented in this user interface, preferably as a button, and the task names may be shortened as necessary if display space of the button is constrained. The labelled button having the task's name preferably operate as a type of hyperlink, whereby the user/viewer can immediately switch to the activity, view, etc. of each of the tasks by selecting the button containing the applicable name from the task bar. In other words, the user or viewer is redirected by the application to the function represented by the task button by selecting the labelled hyperlink. Preferably, the task entry associated with the currently-displayed work unit view may be shown in a different graphical representation (e.g., using a different color, font, or highlighting). In preferred embodiments, there may be provided a display having a selectable “X” in the task bar entry for each task: if the user clicks on the “X”, then its associated task may be ended and the view of its work unit may be removed. A user interface may be web-based, application based, or a combination.

In accordance with a preferred aspect of the present invention, a person skilled in the relevant art would generally understand the term “application” or “application software” to refer to a program or group of programs designed for end users. While there are system software, typically but not limited to, lower level programs (e.g. interact with computers at a basic level), application software resides above system software and may include, but is not limited to database programs, word processors, spreadsheets, etc. Application software may be grouped along with system software or published alone. Application software may simply be referred to as an “application”.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving”, “creating”, “providing”, “communicating” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices. As used herein, reference to the “transmission”, “processing”, “interpretation” or the like of data associated with a cloud may refer to advancing through logic contained in the guideline.

According to the invention, one or more cloud communication network systems, platforms, devices, methods, computer-readable media, and/or cooperating environments may be disclosed.

The invention is contemplated for use in association with one or more cooperating environments, to afford increased functionality and/or advantageous utilities in association with same. The invention, however, is not so limited.

Certain novel features which are believed to be characteristic of the cloud communication network system, platform, device, method, computer readable medium, and/or certain features of the engine, platform, device, system, method, computer readable medium which are novel in conjunction with the cooperating environment, according to the present invention, as to their organization, use, and/or method of operation, together with further objectives and/or advantages thereof, may be better understood from the accompanying disclosure in which presently preferred embodiments of the invention are disclosed by way of example. It is expressly understood, however, that the accompanying disclosure is for the purpose of illustration and/or description only, and is not intended as a definition of the limits of the invention.

Naturally, in view of the teachings and disclosures herein, persons having ordinary skill in the art may appreciate that alternate designs and/or embodiments of the invention may be possible (e.g., with substitution of one or more steps, algorithms, processes, features, structures, parts, components, modules, utilities, etc. for others, with alternate relations and/or configurations of steps, algorithms, processes, features, structures, parts, components, modules, utilities, etc).

Although some of the steps, algorithms, processes, features, structures, parts, components, modules, utilities, relations, configurations, etc. according to the invention are not specifically referenced in association with one another, they may be used, and/or adapted for use, in association therewith.

One or more of the disclosed steps, algorithms, processes, features, structures, parts, components, modules, utilities, relations, configurations, and the like may be implemented in and/or by the invention, on their own, and/or without reference, regard or likewise implementation of one or more of the other disclosed steps, algorithms, processes, features, structures, parts, components, modules, utilities, relations, configurations, and the like, in various permutations and combinations, as may be readily apparent to those skilled in the art, without departing from the pith, marrow, and spirit of the disclosed invention.

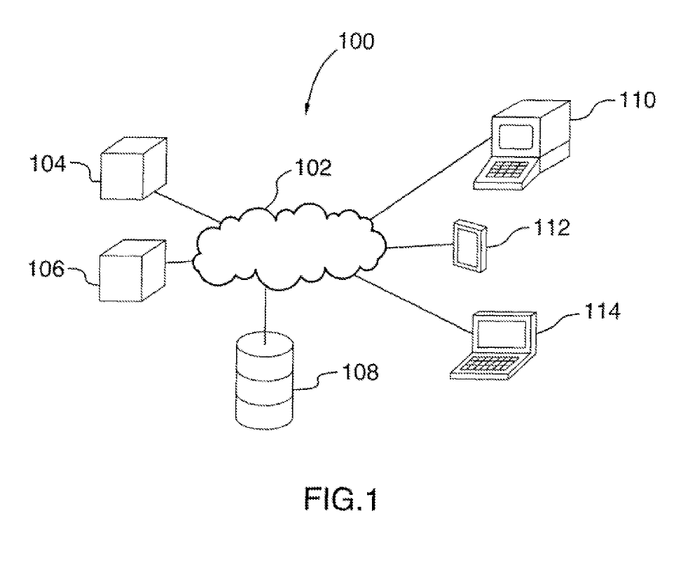

FIG. 1 depicts a schematic representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections such as wire and/or wireless communication links.

In the depicted example, server 104 and server 106 are connected to network 102 along with storage unit 108. In addition, clients 110, 112, and 114 are also connected to network 102. These clients 110, 112, and 114 may be, for example, personal computers, network computers, another data processing system or the like. In the depicted example, servers 104, 106 provide data and applications to the clients 110, 112, and 114. Clients 110, 112, and 114 are clients to servers 104, 106 in the depicted example. Distributed data processing system 100 may include additional servers, clients, and other devices not shown.

In the depicted example, distributed data processing system 100 may be implemented to include a number of different types of networks, such as for example, the Internet, an intranet, a local area network (LAN), a wide area network (WAN), or the like. FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference again to FIG. 1, one or more of the server computing devices, e.g., server 104 and/or 106, may provide a cloud storage service by having cloud storage service applications executing on one or more processors of the servers 104 and/or 106. The servers 104 and/or 106 may have associated storage devices, such as network attached storage unit 108 or the like.

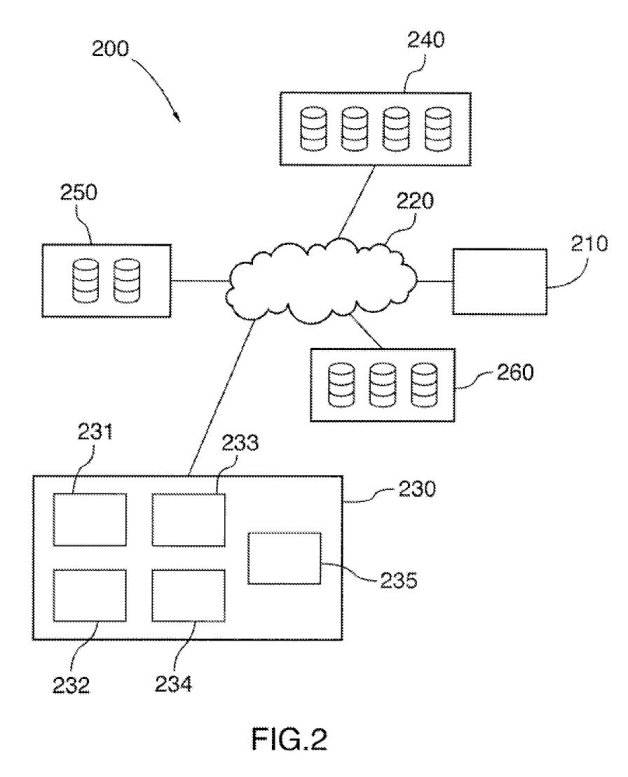

FIG. 2 is a schematic of a cloud storage system 230 in accordance with an embodiment of the present invention. As shown in FIG. 2, the system 230 includes a business specific web service 231, data normalization engine 232, data routing engine 233, application programming interfaces 234, and data transmission configuration 235.

The elements 231-235 may interface with each other through a data communications mechanism (not show), such as a bus or the like, so that the elements 231-235 may work in conjunction with each other to provide cloud storage services to users/customers accessing the server 230 via a client computing device 210 and the data network 220, which may be the Internet.

With these mechanisms in place, a user of a client computing device 210 may communicate with the server 230 via the data network (Internet) 220 in order to utilize the cloud storage system provided by the server 230.

Embodiments of the present invention are directed to systems, methods, devices and computer readable media that comprise:
one or more web services 231 capable of providing specific business functions such as, but not limited to, inventory tracking, medical protocols, reporting, etc.;
an application programming interface (“API”) 234 adapted to send and receive different types of data items;
a data routing engine (alternately, a triggering engine) 233 that is preferably adapted to determine, based on one or more configurable rules, whether new or existing data items should be transmitted, uploaded or sent to another related cloud system;
a data normalization engine or component 232 that is preferably adapted to analyze and map incoming data elements to known expected values. In one embodiment, if there are two ways to indicate temperature (e.g., Celsius and Fahrenheit), this component would determine if an element is temperature and map it to the appropriate data;
a data transmission configuration engine 235 that facilitates the configuration of which data items (and which attributes of those data items) can be communicated (e.g., transmitted, sent, uploaded, etc.) to other cloud systems based on, for example, data category, data item and/or a data item attribute (e.g., data category=clinical data; data item=patient demographics; and data item attribute=date of birth); and/or
a database 240, 250, 260 adapted to host permanent and temporary data elements including, but not limited to: data elements for cloud operation; data elements for storage; configuration for data routing or triggering engine; configuration for data transmission engine; and configuration for data normalization engine.

In preferable embodiments, the cloud services 230 and database 240, 250, 260 may reside on a shared hardware, a virtual machine, a shared virtual machine or a dedicated hardware configuration. In alternate embodiments, the cloud services 230 and database 240, 250, 260 may also function on non-traditional setups such as a mobile device or a collection of mobile devices in a networked environment.

Each cloud system 200 could have multiple users, configurations, and devices (collectively clients 210) connected to it. These devices could be any type of device including mobile phones, tablets, laptops, diagnostic devices, smart TVs, video game systems, smart appliances, among others.

Data being transported within the cloud system 200 could be any type of data, including but not limited to clinical data, operational data, or device content data, configuration data, temporary or permanent data, etc. The foregoing enumerated list should not be considered limiting with respect to the types, purpose and/or usage of data that may be transported within the system 200.

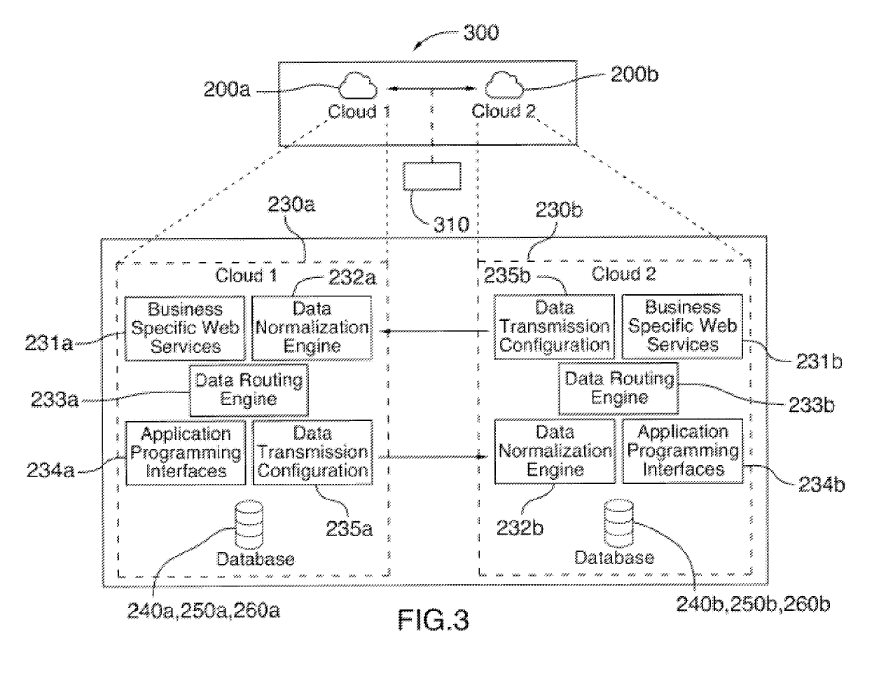

As depicted in FIG. 3, in a preferred embodiment, two cloud systems 200a,b may be in communication with eachother. Such a configuration may be considered the simplest configuration of a cloud communication network 300. The two cloud systems 200a,b could be located at any location, such as on the same hardware, in the same facility, on a mobile device, across the world. The relative location of each system 200a,b is irrelevant. The connection between two cloud systems 200a,b could be any type of communication transport mechanism, such as LAN, WiFi, GSM, Bluetooth, USB, email, SMS, and/or other IoT protocols and/or standards. Advantageously, the communication connection between the two cloud systems 200a,b does not need to always be active. In preferable embodiments of the present invention, the network 300 is adapted to reconcile the data associated with each of the cloud systems 200a,b within the network 300. The connection between the two clouds 200a,b may preferably be facilitated with the use of a transport device 310 that when connected to a source cloud (i.e., either cloud 200a or cloud 200b), is adapted to synchronize or receive all of the relevant and/or requested data for transmission. Preferably, the data received (or uploaded) by the device 310 is stored in a temporary local database (not shown) and subsequently transmitted to the target cloud (i.e., either cloud 200a or cloud 200b) when a communication connection is established between the target cloud and the transport device 310.

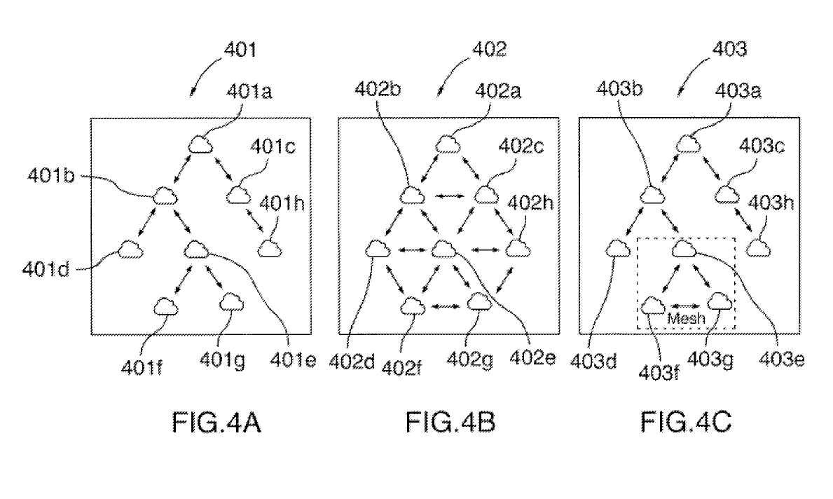

Various configurations may be used to connect two or more clouds 200 to establish a cloud network 300 for communication purposes. FIGS. 4A-C depict three preferred configurations including: (1) a hierarchy 401 (as shown in FIG. 4A); (2) a mesh 402 (as shown in FIG. 4B); and (3) a hybrid 403 (as shown in FIG. 4C). A given configuration will preferably be better suited for one application versus other applications. The configurations shown in FIGS. 4A-C are adapted to facilitate a wide array of data transmission, data privacy and user access level capabilities.

FIG. 4A is preferably adapted for a location where the clouds 401f and 401g have decent connectivity, and are not required to interact (e.g., do not have a business need). An example of this situation is separate disconnected hospital clouds. 401f and 401g are generally not interacting but can interact with a parent country- or city-based cloud to share data.

FIG. 4B is preferably adapted for situations involving many players, entities, users who all need to talk to each other. An example may be a network of country disease surveillance clouds where each cloud is for a country and there is a need for neighbouring countries to talk to each other more frequently to handle cross-border surveillance.

FIG. 4C is preferably adapted for situations in which the local clouds need to interact frequently (e.g., in a city-based hospital network). 403f and 403g may be required to communicate with each other frequently using data transport devices due to the frequent travel of health administrators with the network of hospitals.

### Data Transport Devices

The system of the present invention is preferably adapted to send data between clouds in a network in a non-consistent (i.e., unstable or intermittent) data connectivity setting with the use of alternative transport mechanism 310 (as best shown in FIG. 3. Existing or future data transmission technologies, including but not limited to LAN, WiFi, Bluetooth, USB, Email and SMS, among others, can preferably be used,

Preferred embodiments of the present invention may comprise a temporary data transport device 310 (as best depicted in FIG. 3) that would, synchronize data with a source cloud when the device 310 is in range to temporarily receive and store data from the source cloud. This data communication, or synchronization, may occur using any existing or future data transport device technology (including, but not limited to, LAN, WiFi, Bluetooth, USB, Email, SMS, etc). The device 310 is adapted to temporarily store the data from the source cloud until it is able to synchronize or upload the data to a target cloud, such as when full Internet connectivity is available to the data transport device 310 or when the transport device 310 is within range of the target cloud for direct data transmission. Data transmission from the device 310 to the target cloud preferably also uses existing or future communication technologies (including, but not limited to, LAN, WiFi, Bluetooth, USB, Email, SMS, etc).

An example of a transport device may be a cellular phone, a tablet computer, a laptop computer, diagnostic devices, smart TVs, video game systems, smart appliances, among others, that is preferably equipped with software programmed to automatically or semi-automatically establish a communication connection to a source cloud when in proximity range and automatically initiate the synchronization process to receive the requested data from the source cloud database. In preferable embodiments, the software is programmed to continue searching for communication connectivity to a desired target cloud, whether over the Internet or via local connectivity (for example, Bluetooth), and when the connection is established, automatically send or transmit the data to the target cloud.

### Example #1

### Enabling Progressive Data Access

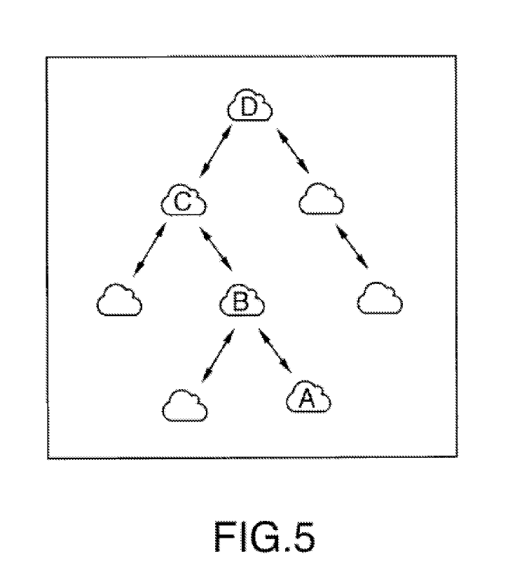

FIG. 5 depicts a cloud network having a hierarchy configuration and the collection of data comprising rapid diagnostic test (“RDT”) results from Malaria testing. In this example, such data may include patient demographics, health worker name and medication prescribed. This data is collected by an RDT device (not shown) that sends the information to Cloud A.

Cloud A is preferably configured to send or transmit all of the data received from the RDT device to Cloud B. If the data associated with Cloud B are configured similarly to Cloud A (e.g., comprises RDT results from Malaria testing of children), then Cloud B is transformed into a large repository of RDT Malaria testing results, patient demographics, health workers and prescription information.

As shown in FIG. 5, Cloud B is preferably configured to send or transmit all requested records to Cloud C but, for example without Patient Demographics. If the data associated with Cloud C are configured similarly to Clouds A and B (e.g., comprises RDT results from Malaria testing of children), then Cloud C becomes an even larger repository of RDT Malaria testing results, health workers and prescription information.

As depicted in FIG. 5, Cloud C is preferably configured to send or transmit only the data for positive RDT test results in Children to Cloud D and only to send test results and prescription information (i.e., no health worker info). The transmission of data from Cloud C and Cloud D results in the creation of a repository for positive test results with medication prescribed associated with Cloud D.

In preferable embodiments of the invention, the configuration of Clouds A, B, C, and D depicted in FIG. 5 comprises the creation of a configuration file (e.g., using the data transmission configuration 235 shown in FIG. 2) that lists the classification of information (e.g., test results, patient demographics, health workers, prescription information, etc.) that should be transmitted to a target cloud. In addition, as demonstrated in Example #1, a cloud may be both a source cloud and a target cloud (e.g., Cloud B is a target cloud when receiving data from Cloud A and a source cloud when sending data to Cloud C).

As described in Example #1 in association with FIG. 5, the cloud communication network system of the present invention is adapted to disseminate information, facilitate progressive data transmission and form purpose specific clouds (i.e., clouds that are only associated with a particular type and/or classification of data) within the same cloud network.

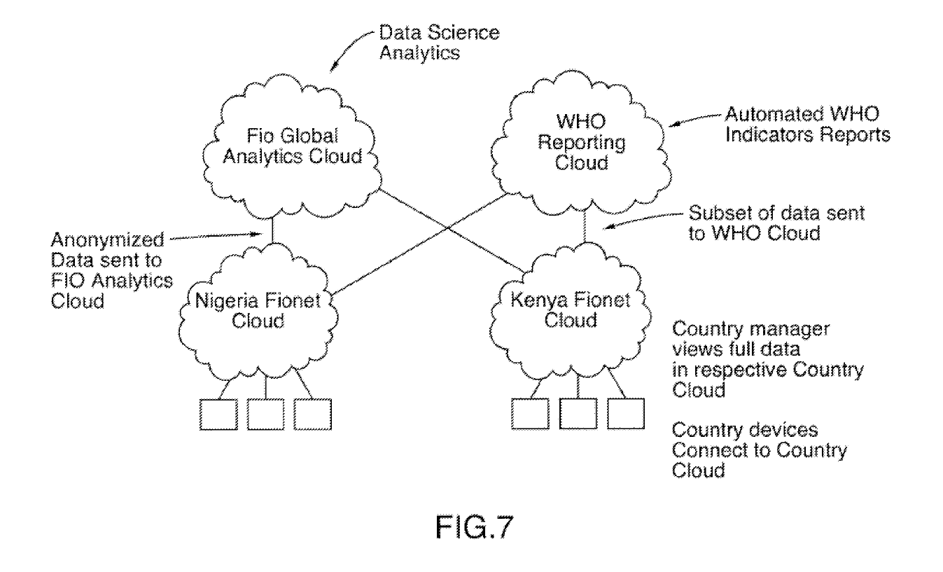

FIG. 7 depicts a preferred embodiment of progressive data access with different clouds having subsets of data for different purposes.

### Example #2

### Hierarchy Based Data Access

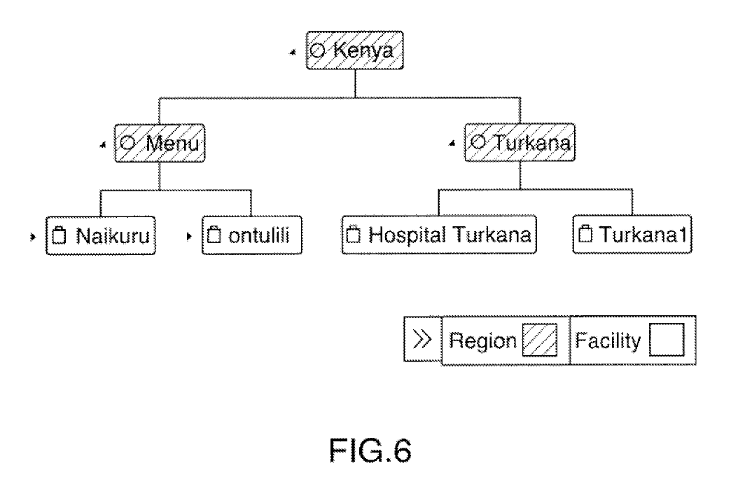

As shown in FIG. 6, users are assigned to a node in a hierarchy network. For example, users may be assigned to the “Meru” region of FIG. 6. In this example, a region assignment defines the user's scope of access to the data residing in the cloud communication network. For example, if a user is a health worker using a device client (e.g., a Fionet device), assignment to the “Meru” region will allow the health worker to access any device client (e.g., Fionet device) in that region. A health worker assigned to the Meru region would therefore not have access to the device clients associated with the Turkana region.

In preferable embodiments, this hierarchy also exists for data reports that are associated with data portals (e.g., the Fionet portal). Reports are generated to only allow users to view the subset of the data that is within their respective “scope”. In other words, users assigned to the Meru region will only be able to generate reports for data relevant to the Meru region.

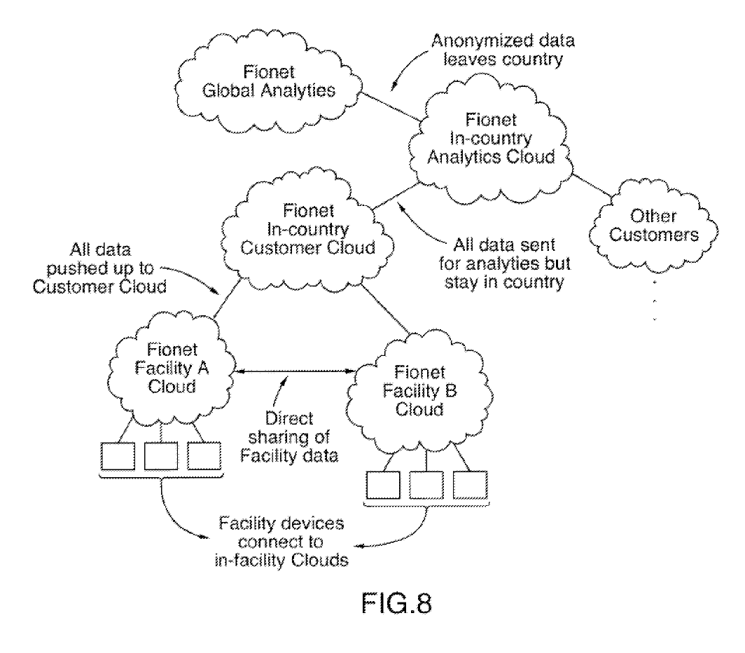

FIG. 8 depicts a preferred embodiment of facility specific clouds that may contribute up to a customer cloud (i.e., transfer data from facility specific clouds to a customer cloud), then to an in-country analytics cloud for in-country analysis and/or insights and finally a global analytics cloud that has a subset of the data.

### Additional Application Examples

Other example uses of the cloud communication network include:
The creation of local data redundant cloud communication networks to ensure data redundancy within a specific region.
The creation of global data redundant cloud communication networks to ensure data redundancy across a large, geographically distributed area.
The formation of facility/department specific cloud communication networks where the cloud is focused on maintaining facility information and data and routing necessary data to national clouds based on national guidelines for data collection.
A service-type cloud communication network where a cloud is focused on a type of service (e.g., Lab Services) and can collect all data related to the service area it's serving (i.e., all lab referrals show up at the lab cloud).
External Stakeholder Clouds where de-identified data can be automatically collected and shared with third parties.

### Data Store

A preferred embodiment of the present invention provides a system comprising data storage (e.g. databases 240, 250, 260 in FIG. 2) that may be used to store all necessary data required for the operation of the system. A person skilled in the relevant art may understand that a “data store” refers to a repository for temporarily or persistently storing and managing collections of data which include not just repositories like databases (a series of bytes that may be managed by a database management system (DBMS)), but also simpler store types such as simple files, emails, etc. A data store in accordance with the present invention may be one or more databases, co-located or distributed geographically. The data being stored may be in any format that may be applicable to the data itself, but may also be in a format that also encapsulates the data quality.

As shown in FIGS. 2 and 3, various data stores or databases may interface with the system of the present invention, preferably including, without limitation, proprietary databases, epidemiologic databases, medical records databases, UN and major/international healthcare institution databases, healthcare and emergency infrastructure databases, education and economic databases, news databases, demographic databases, communication and military infrastructure databases, and weather, travel, topographic databases.

A clinical and healthcare database may preferably contain, among other things, diagnostic and medical data (clinical information), such as, for example, one or more of the following, which may or may not be related to medical events: (a) test results from diagnostic devices equipped with remote data transfer systems and/or global positioning or localization features; (b) information from UN databases and major healthcare international institutions; and/or (c) scenarios and knowledge data.

A sociological database may preferably contain, among other things, sociological data (human information), such as, for example, one or more of the following: (a) population information from local and/or international demographic databases; (b) political and/or organization systems in the area and/or from international databases; (c) education and/or economic systems in the area and/or from international databases; and/or (d) information from news and/or newspapers, drawn from the Internet or elsewhere.

An infrastructure database may preferably contain, among other things infrastructure data or information, such as, for example, one or more of the following: (a) information concerning healthcare infrastructure; (b) information concerning communication infrastructures; and/or (c) information concerning emergency and/or military infrastructure; all preferably drawn from local and/or international databases.

A geophysics database may preferably contain, among other things, geophysics data or information, such as, for example, one or more of the following: (a) weather and/or climatic information from local databases; and/or (b) topographic information from local and/or international databases.

The foregoing description has been presented for the purpose of illustration and maybe not intended to be exhaustive or to limit the invention to the precise form disclosed. Other modifications, variations and alterations are possible in light of the above teaching and may be apparent to those skilled in the art, and may be used in the design and manufacture of other embodiments according to the present invention without departing from the spirit and scope of the invention. It may be intended the scope of the invention be limited not by this description but only by the claims forming a part of this application and/or any patent issuing herefrom.

What is claimed is:

1. A cloud communication network system for data transfer, comprising:
(a) a source cloud in communication with a network comprising: (i) a first cloud database configured to store source data; (ii) a first business specific web services engine; (iii) a first data routing engine; (iv) a first application programming interface engine; (v) a first data normalization component; and (vi) a first data transmission configuration engine to generate configured source data;
(b) a target cloud in communication with the network comprising: (i) a second cloud database configured to store target data and/or synchronized data; (ii) a second business specific web services engine; (iii) a second data routing engine; (iv) a first application programming interface engine; (v) a second data transmission configuration engine; and (vi) a second data normalization engine to analyze and categorize the configured source data; and
(c) a data transport device adapted to automatically receive the configured source data from the first data transmission configuration engine and transmit the configured source data to the second data normalization engine to generate the synchronized data;
whereby the configured source data can be transmitted from the source cloud to the target cloud in unstable connectivity settings.

2. The cloud communication network system of claim 1 wherein the first and/or second business specific web services engine generates specific business functions selected from the group consisting of inventory tracking, medical protocols and reports.

3. The cloud communication network system of claim 1 wherein the first and/or second application programming interface engine sends and receives different types of data items.

4. The cloud communication network system of claim 1 wherein the first and/or second data routing engine automatically determine if new or existing data items should be sent to another related cloud system.

5. The cloud communication network system of claim 1 wherein the first and/or second data transmission configuration engines configure data using data category, data item and/or data item attribute.

6. The cloud communication network system of claim 1 wherein the first and/or second database comprises data elements selected from the group consisting of: data elements for cloud operation; data elements for storage, configuration parameters for data routing engine, configuration parameters for data transmission engine, and configuration parameters for data normalization engine.

7. The cloud communication network system of claim 1 comprising shared hardware, a virtual machine, a shared virtual machine and/or a dedicated hardware configuration.

8. The cloud communication network system of claim 1 wherein the system is adapted to connect to multiple users and/or client devices. the source clouds.

9. The cloud communication network system of claim 1 wherein the source data, the target data and/or the synchronized data is selected from the group consisting of clinical data, operational data, device content data, configuration data, temporary and permanent data.

10. The cloud communication network system of claim 1 whereby the cloud systems can be local or remote.

11. The cloud communication network system of claim 1, further comprising a plurality of clouds having a hierarchy configuration, a mesh configuration, or a hybrid configuration.

12. A method for transferring data in a cloud communication network system with unstable connectivity settings, comprising:
(a) providing a source cloud in communication with a with a network comprising: (i) a first cloud database configured to store source data; (ii) a first business specific web services engine; (iii) a first data routing engine; (iv) a first application programming interface engine; (v) a first data normalization component; and (vi) a first data transmission configuration engine to generate configured source data;
(b) providing a target cloud in communication with the network comprising: (i) a second cloud database configured to store target data and/or synchronized data; (ii) a second business specific web services engine; (iii) a second data routing engine; (iv) a first application programming interface engine; (v) a second data transmission configuration engine; and (vi) a second data normalization engine to analyze and categorize the configured source data;
(c) automatically transmitting the configured source data from the first data transmission configuration engine to a data transport device; and
(d) automatically transmitting the configured source data from the data transport device to the second data normalization engine to generate the synchronized data.

13. The method of claim 12, wherein the first and/or second business specific web services engine generates specific business functions selected from the group consisting of inventory tracking, medical protocols and reports.

14. The method of claim 12, wherein the first and/or second application programming interface engine sends and receives different types of data items.

15. The method of claim 12, wherein the first and/or second data routing engine automatically determine if new or existing data items should be sent to another related cloud system.

16. The method of claim 12, wherein the first and/or second data transmission configuration engines configure data using data category, data item and/or data item attribute.

17. The method of claim 12, wherein the first and/or second database comprises data elements selected from the group consisting of: data elements for cloud operation; data elements for storage, configuration parameters for data routing engine, configuration parameters for data transmission engine, and configuration parameters for data normalization engine.

18. The method of claim 12, wherein the system is adapted to connect to multiple users and/or client devices. the source clouds.

19. The method of claim 12, wherein the source data, the target data and/or the synchronized data is selected from the group consisting of clinical data, operational data, device content data, configuration data, temporary and permanent data.

20. The method of claim 12, wherein the cloud systems can be local or remote.

21. The method of claim 12, further comprising a plurality of clouds having a hierarchy configuration, a mesh configuration, or a hybrid configuration.

22. A non-transitory computer readable medium encoded with executable instructions for transferring data in a cloud communication network system with unstable connectivity settings, comprising:
(a) providing a source cloud in communication with a with a network comprising: (i) a first cloud database configured to store source data; (ii) a first business specific web services engine; (iii) a first data routing engine; (iv) a first application programming interface engine; (v) a first data normalization component; and (vi) a first data transmission configuration engine to generate configured source data;
(b) providing a target cloud in communication with the network comprising: (i) a second cloud database configured to store target data and/or synchronized data; (ii) a second business specific web services engine; (iii) a second data routing engine; (iv) a first application programming interface engine; (v) a second data transmission configuration engine; and (vi) a second data normalization engine to analyze and categorize the configured source data;
(c) automatically transmitting the configured source data from the first data transmission configuration engine to a data transport device; and
(d) automatically transmitting the configured source data from the data transport device to the second data normalization engine to generate the synchronized data.

23. The computer readable medium of claim 22, wherein the first and/or second business specific web services engine generates specific business functions selected from the group consisting of inventory tracking, medical protocols and reports.

24. The computer readable medium of claim 22, wherein the first and/or second application programming interface engine sends and receives different types of data items.

25. The computer readable medium of claim 22, wherein the first and/or second data routing engine automatically determine if new or existing data items should be sent to another related cloud system.

26. The computer readable medium of claim 22, wherein the first and/or second data transmission configuration engines configure data using data category, data item and/or data item attribute.

27. The computer readable medium of claim 22, wherein the first and/or second database comprises data elements selected from the group consisting of: data elements for cloud operation; data elements for storage, configuration parameters for data routing engine, configuration parameters for data transmission engine, and configuration parameters for data normalization engine.

28. The computer readable medium of claim 22, wherein the system is adapted to connect to multiple users and/or client devices. the source clouds.

29. The computer readable medium of claim 22, wherein the source data, the target data and/or the synchronized data is selected from the group consisting of clinical data, operational data, device content data, configuration data, temporary and permanent data.

30. The computer readable medium of claim 22, wherein the cloud systems can be local or remote.

31. The computer readable medium of claim 22, further comprising a plurality of clouds having a hierarchy configuration, a mesh configuration, or a hybrid configuration.
